(19) United States
(12) Patent Application Publication
(10) Pub. No.: US 2021/0103175 A1
(43) Pub. Date: Apr. 8, 2021

(54) LIQUID CRYSTAL PANEL AND DISPLAY DEVICE

(71) Applicant: SAKAI DISPLAY PRODUCTS CORPORATION, Sakai-shi, Osaka (JP)

(72) Inventor: SHINICHI SUGIMOTO, Sakai-shi, Osaka (JP)

(73) Assignee: SAKAI DISPLAY PRODUCTS CORPORATION, Sakai-shi, Osaka (JP)

(21) Appl. No.: 16/321,406

(22) PCT Filed: Jul. 28, 2016
(86) PCT No.: PCT/JP2016/072191

§ 371 Date: Jan. 28, 2019

(51) Int. Cl. G02F 1/1345; G02F 1/1339; G02F 1/1365; G02F 1/1343

(52) U.S. Cl. CPC G02F 1/13452; G02F 1/1339; G02F 2201/50; G02F 1/134309; G02F 1/1365

(57) ABSTRACT

A TFT substrate (20) and a CF substrate are connected to each other with a space therebetween via a seal section (22) disposed along the peripheral ends of the TFT substrate (20) and the CF substrate. A liquid crystal is sealed inside of the seal section (22). On a TFT substrate (20) portion inside of the seal section (22), preliminary wiring lines (39a, 39b) are formed along the seal section (22). On the TFT substrate (20), a conductor (41) is disposed between the seal section (22) and the preliminary wiring lines (39a, 39b) without being in contact with the seal section (22) and the preliminary wiring lines (39a, 39b).

### TECHNICAL FIELD

The present invention relates to a liquid crystal panel in which a liquid crystal is enclosed between two substrates and a display device including the liquid crystal panel.

### BACKGROUND ART

A liquid crystal display device which displays an image includes a liquid crystal panel (Patent Literature 1, for example). In the liquid crystal panel disclosed in Patent Literature 1 two substrates are bonded to each other through a seal provided along peripheral edges of the substrates with a space therebetween. Liquid crystals are sealed inside of the seal (in an area surrounded by the seal).

A plurality of pixel electrodes is formed on one of the two substrates. A common electrode is formed on the other substrate. Each of the pixel electrodes faces the common electrode. Voltage is applied to a pixel electrode with reference to the potential of the common electrode. The state of liquid crystal molecules varies according to the voltage applied to the pixel electrode. The intensity of light emitted out of the liquid crystal panel through the pixel electrodes is determined according to the state of the liquid crystal molecules. An image based on image data is displayed on the liquid crystal panel by applying voltage to the plurality of pixel electrodes according to the image data.

In the one substrate, common wiring (Vcom wiring) which conducts electricity to the common electrode is formed along the seal. In the liquid crystal panel disclosed in Patent Literature 1, external wiring (GND wiring) is additionally provided farther outside of the seal than the Vcom wiring. Accordingly, when electrostatic discharge (ESD) occurs due to a person touching the liquid crystal panel for example, an electric current occurring due to a flow of static electricity thereinafter referred to as an electrostatic current) flows to the GND wring and not the Vcom wiring. Therefore, the electrostatic current does not flow to circuitry, wiring, or the like located near the Vcom wiring. As a result, malfunction of the circuitry, a break of the wiring, fusion of adjacent wiring, or the like is prevented from occurring.

### CITATION LIST

### Patent Literature

### Patent Literature 1

Japanese Patent Application Laid-Open Publication No. 2015-161751

### SUMMARY OF INVENTION

### Technical Problem

Static electricity also occurs during the manufacturing process of a liquid crystal panel. In the liquid crystal panel a polarizing plate is attached to a plate surface of a substrate on which a common electrode is located. In a situation in which a foreign object is caught between the polarizing plate and the substrate or a scratch occurs in the polarizing plate for example, the polarizing plate is removed from the substrate and a new polarizing plate is attached. When the polarizing plate is removed from the substrate, the static electricity occurs.

In a conventional liquid crystal panel, a common line conducts electricity to the common electrode through a seal, and a plurality of internal lines is located in the vicinity of the common line inside of the seal. Upon a break occurring in a line connected to a plurality of pixel electrodes for example, the internal lines are used as auxiliary lines for connecting two lines that have been divided by the break.

In the liquid crystal panel described above, the static electricity occurring when the polarizing plate is removed from the substrate on which the common electrode is located flows to the common line through the seal and further moves from the common line to the internal lines. Thus, a large electric current (electrostatic current) flows to the internal lines. Therefore, a break of the internal lines, fusion of two internal lines, or the like may occur. Also, the static electricity may flow from the internal lines to lines in an active area (source lines or gate lines) and destroy the lines or a circuit element in the active area.

In particular, a distance between the common line and the internal lines is short in a liquid crystal panel with a narrow bezel edge. The bezel edge has a narrow non-display area in which no image is displayed. As such, the electrostatic current easily flows to the internal lines and causes destruction of a circuit (break, fusion, or the like of the internal lines).

The present invention takes these circumstances into account and aims to provide a liquid crystal panel in which destruction of a circuit by static electricity may be prevented, and a display device including the liquid crystal panel.

### Solution to Problem

A liquid crystal panel according to the present invention is a liquid crystal panel in which two substrates are joined through a joining member arranged between the two substrates along peripheral edges of the substrates with a space therebetween and in which a liquid crystal is enclosed inside of the joining member. The liquid crystal panel includes at least one internal line located on one of the two substrates inside of the joining member along the joining member, and a conductor arranged on the one substrate between the joining member and the internal line so as to be out of contact with the joining member and the internal line.

A display device according to the present invention includes the liquid crystal panel described above and an irradiating section which irradiates the liquid crystal panel with light. The liquid crystal panel displays an image using the light radiated by the irradiating section.

### Advantageous Effects of Invention

According to the present invention, a liquid crystal panel in which destruction of a circuit by static electricity may be prevented and a display device including the liquid crystal panel are provided.

### BRIEF DESCRIPTION OF DRAWINGS

FIG. 1 is a schematic view of a display device according to a first embodiment.

FIG. 2 is a front view of a liquid crystal panel.

FIG. 3 is a partial front view of the liquid crystal panel with a CF substrate and a polarizing plate removed.

FIG. 4 is another partial front view of the liquid crystal panel with the CF substrate and the polarizing plate removed.

FIG. 5 is an explanatory diagram of auxiliary lines.

FIG. 6 is another explanatory diagram of the auxiliary lines.

FIG. 7 is a partial enlarged view of a substrate line.

FIG. 8 is a partial front view of a liquid crystal panel according to a second embodiment.

FIG. 9 is an external view of a conductor according to a third embodiment.

FIG. 10 is an external view of a conductor according to a fourth embodiment.

FIG. 11 is a partial enlarged view of a substrate line according to a fifth embodiment.

FIG. 12 is a partial front view of a liquid crystal panel according to a sixth embodiment.

### DESCRIPTION OF EMBODIMENTS

The following describes embodiments of the present invention with reference to the accompanying drawings.

### First Embodiment

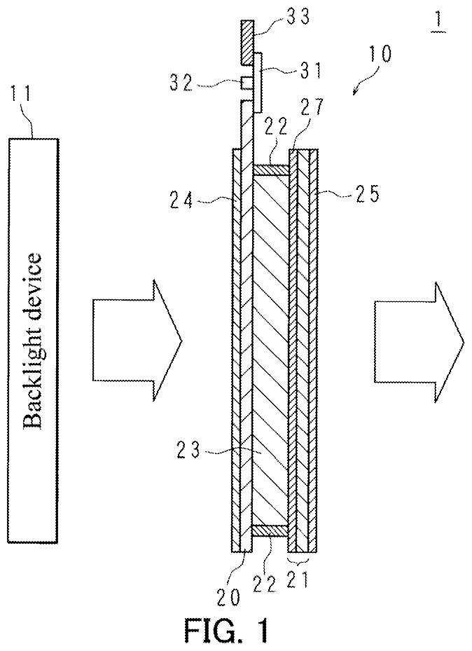

FIG. 1 is a schematic view of a display device 1 according to a first embodiment. The display device 1 induces a rectangular plate-shaped liquid crystal panel 10 and a backlight device 11. A vertical cross-section of the liquid crystal panel 10 is illustrated in FIG. 1. The backlight device 11 (irradiating section) irradiates the liquid crystal panel 10 with light. The liquid crystal panel 10 displays an image using the light radiated by the backlight device 11.

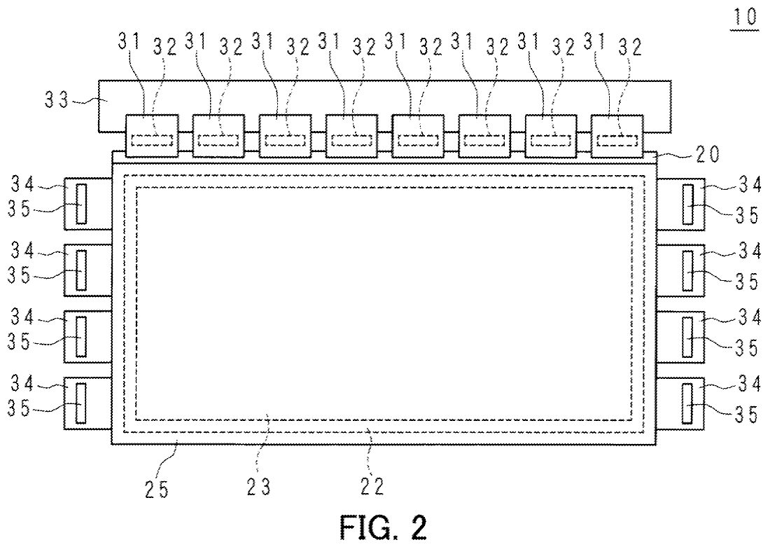

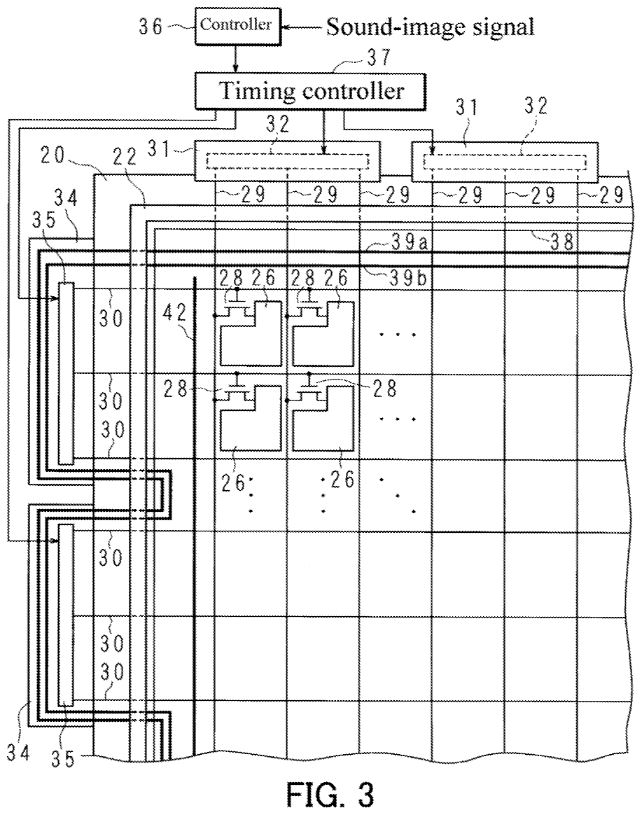

FIG. 2 is a front view of the liquid crystal panel 10. As illustrated in FIGS. 1 and 2, the liquid crystal panel 10 includes a rectangular TFT substrate 20 through which the light radiated by the backlight device 11 enters and a rectangular CF substrate 21 which emits the light. The TFT substrate 20 includes a plurality of pixel electrodes 26, a plurality of thin-film transistors (TFT) 28, and the like (refer to FIG. 3). The CF substrate 21 includes a common electrode 27 (second electrode), an unillustrated color filter (CF), and the like. The light radiated by the backlight device 11 enters a back surface of the TFT substrate 20 and is emitted from a front surface of the CF substrate 21. The TFT substrate 20 and the CF substrate 21 are transparent and composed of glass, for example.

A front surface of the TFT substrate 20 faces a back surface of the CF substrate 21. Between the TFT substrate 20 and the CF substrate 21, a rectangular frame-shaped seal section 22 (joining member) is arranged along peripheral edges of the TFT substrate 20 and the CF substrate 21. The seal section 22 is continuous across an entire periphery of the TFT substrate 20 and the CF substrate 21. The TFT substrate 20 and the CF substrate 21 are joined through the seal section 22 with a space therebetween. The seal section 22 is attached to the TFT substrate 20 and the CF substrate 21. Through the above, a union of the TFT substrate 20 and the CF substrate 21 is realized. A liquid crystal 23 is enclosed inside of the seal section 22 (in an area surrounded by the seal section 22).

A polarizing plate 24 is attached to the back surface of the TFT substrate 20. The light radiated by the backlight device 11 passes through the polarizing plate 24 and the TFT substrate 20 in the stated order. Of the light radiated by the backlight device 11, the polarizing plate 24 allows only light for which the electric field oscillates in a specific direction to pass therethrough.

Similarly, a polarizing plate 25 is attached to the entire front surface of the CF substrate 21. The light radiated by the backlight device 11 passes through the polarizing plate 24, the TFT substrate 20, the liquid crystal 23, the CF substrate 21, and the polarizing plate 25 in the stated order. Of the light which passes through the CF substrate 21, the polarizing plate 25 allows only light for which the electric field oscillates in a specific direction to pass through.

The specific direction determined by the polarizing plate 24 may be the same direction as the specific direction determined by the polarizing plate 25, or a different direction than the specific direction determined by the polarizing plate 25.

FIG. 3 is a partial front view of the liquid crystal panel 10 with the CF substrate 21 and the polarizing plate 25 removed. An upper-left part of the liquid crystal panel 10 seen from the front is illustrated in FIG. 3. Black circles each indicate a connection between two lines. Intersections between two lines without a black circle each indicate that the two lines are not connected.

As illustrated in FIG. 3, a plurality of pixel electrodes 26 is arranged in a lattice on the TFT substrate 20 inside of the seal section 22. The pixel electrodes 26 are transparent and aligned in a left-right direction and an up-and-down direction. The pixel electrodes 26 are plate-shaped, and plate surfaces of the pixel electrodes 26 face the back surface of the CF substrate 21. As illustrated in FIG. 1, a plate-shaped common electrode 27 is located on the CF substrate 21. The common electrode 27 is also transparent. A plate surface of the common electrode 27 faces the plate surfaces of all of the pixel electrodes 26.

Voltage is individually applied to the pixel electrodes 26 with reference to the potential of the common electrode 27. Through the above, the voltage is applied to the liquid crystal 23. The pixel electrodes 26 and the common electrode 27 are configured to apply the voltage to the liquid crystal 23. The common electrode 27 is not illustrated in FIG. 2.

According to the voltage applied to pixel electrodes 26, the state of liquid crystal molecules of the liquid crystal 23 corresponding to the pixel electrodes 26 varies. The oscillation direction of the electric field for the light passing through the liquid crystal 23 varies according to the state of the liquid crystal molecules. The intensity of the light emitted from the polarizing plate 25 varies according to the oscillation direction of the electric field. The intensity of the light emitted from the polarizing plate 25 through the pixel electrodes 26 is adjusted by adjusting the voltage applied to each of the pixel electrodes 26.

The TFTs 28 are provided on the TFT substrate 20 to appropriately apply voltage to the pixel electrodes 26. Drains of the TFTs 28 are connected to the respective pixel electrodes 26. The number of the pixel electrodes 26 is the same as the number of the TFTs 28.

Each of the TFTs 28 functions as a switch. When gate voltage of the TFT 28 is a certain voltage or higher, the TFT 28 is on. When the TFT 28 is on, the voltage can be applied to a corresponding pixel electrode 26 through the drain and a source. When the gate voltage of the TFT 28 is less than the certain voltage, the TFT 28 is off. When the TFT 28 is off, no voltage is applied to the pixel electrode 26 through the drain and the source.

Source lines 29 (electrode lines) of M in number (integer of two or greater) extending in the up-and-down direction are arranged side by side in the left-right direction on the TFT substrate 20. Each of the M source lines 29 is arranged in the vicinity of (left of in the example of FIG. 3) a vertical pixel electrode group corresponding to the source line 29. Herein, the vertical pixel electrode group refers to a plurality of pixel electrodes 26 arranged side by side in the up-and-down direction. Vertical pixel electrode groups of M in number are aligned in the left-right direction. Each of the M source lines 29 also corresponds to a plurality of TFTs 28 having drains connected to the respective pixel electrodes 26 belonging to the vertical pixel electrode group corresponding to the source line 29. The M source lines 29 are connected respectively to the sources of the TFTs 28 corresponding to each source line 29.

Accordingly, each of the M source lines 29 is connected to the pixel electrodes 26 belonging to the vertical pixel electrode group corresponding to the source line 29 through the TFTs 28 corresponding to the source line 29.

In addition, gate lines 30 of N in number (integer of 2 or greater) extending in the left-right direction are arranged side by side in the up-and-down direction on the TFT substrate 20. Each of the N gate lines 30 is arranged in the vicinity of (above in the example of FIG. 3) a horizontal pixel electrode group corresponding to the gate line 30. Herein, the horizontal pixel electrode group refers to a plurality of pixel electrodes 26 aligned in the left-right direction. Horizontal pixel electrode groups of N in number are arranged side by side in the up-and-down direction. Each of the N gate lines 30 also corresponds to a plurality of TFTs 28 having drains connected to the respective pixel electrodes 26 belonging to the horizontal pixel electrode group corresponding to the gate line 30. The N gate lines 30 are connected respectively to the gates of the TFTs 28 corresponding to each gate line 30.

As illustrated in FIGS. 2 and 3, a plurality of printed substrates 31 protrudes upward from an upper part of the front surface of the TFT substrate 20. A source driver 32 is installed on each of the printed substrates 31. The printed substrates 31 are additionally joined to a signal substrate 33. The signal substrate 33 is not illustrated in FIG. 3. In an example illustrated in FIG. 2, there are eight printed substrates 31 and eight source drivers 32.

Source lines 29 of J in number (natural number less than M) are connected to each of the source drivers 32. J is 3 in an example illustrated in FIG. 3. Each of the source drivers 32 individually outputs voltage to the J source lines 29 connected to the source driver 32. When the voltage is output to a source line 29, the voltage is applied one or more pixel electrodes 26 connected to one or more TFTs 28 which are on among the TFTs 28 that are connected to the source line 29.

As illustrated in FIGS. 2 and 3, a plurality of printed substrates 34 protrudes from a left side and a right side of the TFT substrate 20. A gate driver 35 is installed on each of the printed substrates 34. In an example illustrated in FIG. 2, there are eight printed substrates 34 and eight gate drivers 35.

Gate lines 30 of K in number (natural number less than N) are connected to each of the gate drivers 35. K is 3 in an example illustrated FIG. 3. Each of the gate drivers 35 individually outputs voltage to the K gate lines 30 connected to the gate driver 35. When the voltage of a gate line 30 is a certain voltage or greater, all of the TFTs 28 connected to the gate line 30 are on. When the voltage of the gate line 30 is less than the certain voltage, all of the TFTs 28 connected to the gate line 30 are off.

A controller 36 and a timing controller 37 are provided on the signal substrate 33. A sound-image signal including sound data and image data is input to the controller 36. An example of the sound-image signal is the broadcast signal of a television broadcast. The controller 36 extracts the image data from the sound-image signal and outputs the extracted image data to the timing controller 37. The timing controller 37 generates a control signal indicating such things as a timing at which voltage is to be applied to each source line 29 and a timing at which voltage is to be applied to each gate line 30 based on the image data input from the controller 36. The timing controller 37 outputs the generated control signal to the source drivers 32 and the gate drivers 35.

The source drivers 32 apply voltage to the M source lines 29 according to the control signal input from the timing controller 37. The gate drivers 35 apply voltage to the N gate lines 30 according to the control signal input from the timing controller 37. Through the above, voltage is individually applied to the pixel electrodes 26, and the intensity of the light emitted from the polarizing plate 25 through the pixel electrodes 26 is adjusted according to the image data output by the controller 36 to the timing controller 37. As a result, an image based on the image data is displayed on the liquid crystal panel 10.

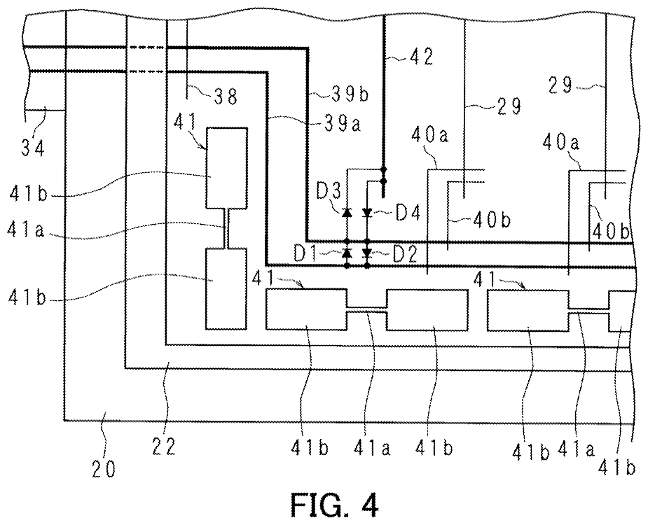

FIG. 4 is another partial front view of the liquid crystal panel 10 with the CF substrate 21 and the polarizing plate 25 removed. A lower-left part of the liquid crystal panel 10 is illustrated in FIG. 4. As illustrated in FIGS. 3 and 4, a common line 38 (second electrode line) is located on the TFT substrate 20 inside of the seal section 22. The common line 38 is along a left part, an upper part, and a right part of the rectangular frame-shaped seal section 22. According to the first embodiment, the common line 38 is not arranged in a position along, a lower part of the seal section 22, which is on a lower part of the TFT substrate 20, and forms a U-shape.

The seal section 22 is conductive. The common line 38 is connected to the common electrode 27 through the seal section 22 in a plurality of positions, and conducts electricity to the common electrode 27. Therefore, the potential of the entire common electrode 27 is stable.

A plurality of (two in the first embodiment) auxiliary lines 39a and 39b (internal lines) are located on the TFT substrate 20 and the printed substrates 34. The two auxiliary lines 39a and 39b are arranged side by side. The two auxiliary lines 39a and 39b extend in the left-right direction between the seal section 22 and an uppermost gate line 30 on an upper part of the TFT substrate 20. On each of the printed substrates 34, the two auxiliary lines 39a and 39b pass between a corresponding gate driver 35 and the edge of the printed substrate 34. Between two adjacent printed substrates 34, the two auxiliary lines 39a and 39b briefly go inside of the seal section 22 on the TFT substrate 20 from one of the printed substrates 34 before entering the other printed substrate 34. On the lower part of the TFT substrate 20, the two auxiliary lines 39a and 39b extend in the left-right direction between the seal section 22 and a lowermost gate line 30.

As described above, the two auxiliary lines 39a and 39b are located on the TFT substrate 20 inside of the seal section 22 along the upper part of the seal section 22, the lower part of the seal section 22, and a portion of either or both of the left part and the right part of the seal section 22 (parts between adjacent printed substrates 34 and parts beneath lowermost printed substrates 34).

As illustrated in FIG. 4, connecting lines 40a are provided to connect the respective M source lines 29 to the auxiliary line 39a on the TFT substrate 20. When the liquid crystal panel 10 is viewed from the front, each connecting line 40a intersects with a corresponding one of the source lines 29 and the auxiliary line 39a. However, the connecting line 40a is separated from the source line 29 and the auxiliary line 39a in a front-back direction.

Similarly, connecting lines 40b are provided to connect the respective M source lines 29 to the auxiliary line 39b on the TFT substrate 20. When the liquid crystal panel 10 is viewed from the front, each connecting line 40b intersects with a corresponding one of the source line 29 and the auxiliary line 39b. However, the connecting line 40b is separated from the source line 29 and the auxiliary line 39b in the front-back direction.

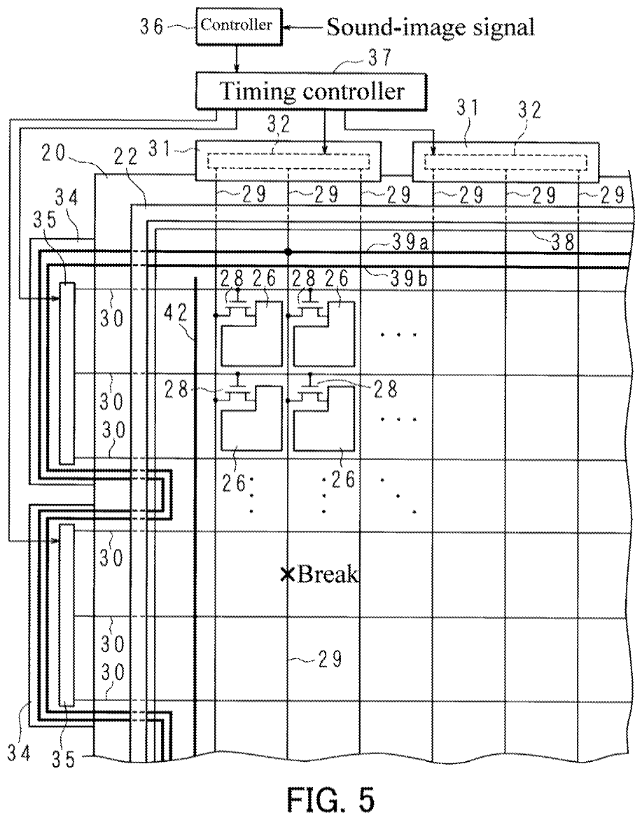

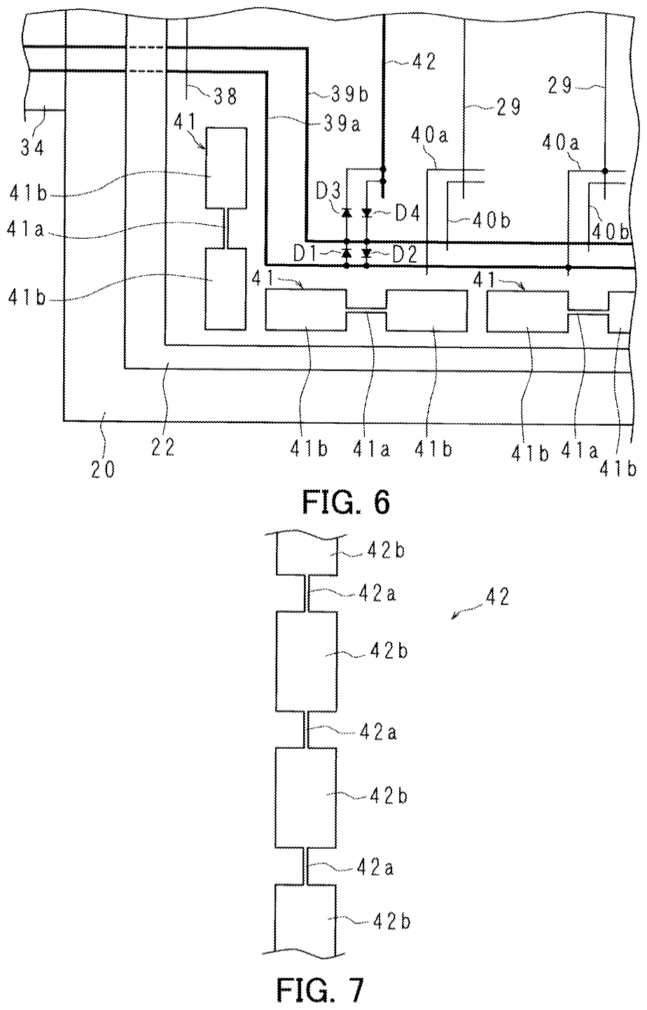

The two auxiliary lines 39a and 39b are used upon a break occurring in a source line 29. FIG. 5 is an explanatory diagram of the auxiliary line 39a. FIG. 6 is another explanatory diagram of the auxiliary line 39a. FIG. 5 corresponds to FIG. 3, and FIG. 6 corresponds to FIG. 4.

When a break occurs in a source line 29 as illustrated in FIG. 5, a source driver 32 cannot output voltage to a lower one of two source lines 29 of the source line 29 that is divided by the break. As such, the source driver 32 cannot apply the voltage to one or more pixel electrodes 26 that are connected to the lower source line 29.

In view of the foregoing, as illustrated in FIG. 5, the upper one of the two source lines 29 of the source line 29 divided by the break is connected to the auxiliary line 39a. For example, the upper source line 29 and the auxiliary line 39a are connected to each other by melting using a laser. Furthermore, as illustrated in FIG. 6, the connecting line 40a corresponding to the source line 29 in which the break has occurred is connected to the lower source line 29 and the auxiliary line 39a for example using a laser. Therefore, the source driver 32 can apply the voltage not only to the one or more pixel electrodes 26 connected to the upper source line 29 but also the one or more pixel electrodes 26 connected to the lower source line 29.

Herein, an example is illustrated using the auxiliary line 39a, but the two source lines 29 divided by the break may be connected in a similar manner using the auxiliary line 39b. In this case, the upper source line 29 is connected to the auxiliary line 39b and the connecting line 40b is connected to the lower source line 29 and the auxiliary line 39b.

As illustrated in FIG. 4, one or more (a plurality in the first embodiment) conductors 41 are arranged on the TFT substrate 20 between the lower part of the seal section 22 and the lowermost auxiliary line 39a which passes in the left-right direction of the two auxiliary lines 39a and 39b. The conductors 41 are out of contact with the seal section 22 and the auxiliary line 39a. The conductors 41 are arranged between the auxiliary line 39a and the seal section 22 and arranged between the auxiliary line 39b and the seal section 22. Each of the conductors 41 is not electrically connected to another conductor. For example, an entire surface of each of the conductors 41 is covered with an insulator.

The conductors 41 are long and plate-shaped. Plate surfaces of the conductors 41 face the back surface of the CF substrate 21. The conductors 41 are arranged over an entire area surrounded by the seal section 22 and the auxiliary line 39a. In each of the conductors 41, the width of part of the conductor 41 is narrower than another part of the conductor 41. Preferably, the width of the part of the conductor 41 is extremely narrower than the other part of the conductor 41. In the first embodiment, the width of a center 41a of each conductor 41 in a longitudinal direction thereof is narrower than both of two joints 41b thereof other than the center 41a.

A lower-right part of the TFT substrate 20 is configured similarly o a lower-left part of the TFT substrate 20 illustrated in FIG. 4.

In the manufacturing process of the liquid crystal panel 10, work of detaching the polarizing plate 25 from the CF substrate 21 is performed when for example a foreign object is caught between the CF substrate 21 and the polarizing plate 25 or a scratch occurs in the polarizing plate 25. At this time, static electricity occurs on the CF substrate 21. The occurring static electricity follows the seal section 22 and flows to the TFT substrate 20. On a lower part of the TFT substrate 20, the occurring static electricity moves to at least one of the conductors 41 arranged in the vicinity of the seal section 22 and flows on to the conductor 41. Thus, the amount of static electricity flowing to the auxiliary lines 39a and 39b through the lower part of the seal section 22 can be reduced. Accordingly, a break or fusion of the auxiliary lines 39a and 39b or wiring in an active area (source line 29 or gate line 30) by the static electricity can be prevented. Additionally, destruction of a circuit element of a TFT 28 or the like by the static electricity can be prevented.

The printed substrates 31 are provided on the upper part of the TFT substrate 20, and the printed substrates 34 are provided on the left and right parts of the TFT substrate 20. Accordingly, a portion of an electrostatic current flowing to the upper part, the left part, and the right part of the seal section 22 flows to the printed substrates 31 and 34. Thus, the electrostatic current is distributed. As such, the amount of static electricity flowing to the auxiliary lines 39a and 39b is reduced even though conductors 41 are not arranged on the upper part, a left part, or the right part of the TFT substrate 20.

Furthermore, the width of the center 41a is narrower than the joints 41b in each of the conductors 41. Accordingly, when the electrostatic current flows to a conductor 41, electric charge concentrates in the center and electric power is converted into heat energy. Therefore, the electrostatic current flowing through the conductor 41 becomes small, and the amount of static electricity moving from the conductor 41 to the auxiliary lines 39a and 39b, which is the amount of electrostatic current flowing through the auxiliary lines 39a and 39b, can be reduced.

Furthermore, a narrow-width part is provided in the center of each of the conductors 41 in the longitudinal direction thereof. As such, an electric current easily flows to the narrow-width center 41a. As a result, the electric power is efficiently converted into heat energy and the electric current flowing through the conductor 41 greatly decreases.

As illustrated in FIG. 4, two diodes D1 and D2 are connected to the two adjacent auxiliary lines 39a and 39b on the TFT substrate 20. An anode of the diode D1 and a cathode of the diode D2 are connected to the auxiliary line 39a. A cathode of the diode D1 and an anode of the diode D2 are connected to the auxiliary line 39b. As such, the two diodes D1 and D2 constitute a so-called diode ring.

In the diodes D1 and D2, the breadth of voltage drop occurring when an electric current flows forward is larger than a maximum value of the voltage applied by the respective source drivers 32. As such, when a source driver 32 is connected to the auxiliary line 39a, the source driver 32 applies no voltage to the auxiliary line 39b through the diode D1. Similarly, when a source driver 32 is connected to the auxiliary line 39b, the source driver 32 applies no voltage to the auxiliary line 39a through the diode D2. In other words, a small electric current output by each of the source drivers 32 does not flow forward through the diode D1 or the diode D2, but a large electric current such as the electrostatic current does flow forward through the diode D1 or the diode 12.

The two adjacent auxiliary lines 39a and 39b are connected by the two diodes D1 and D2. Therefore, when a large electric current flows to one of the adjacent auxiliary lines 39a and 39b, a portion of the electric current flowing to the one of the auxiliary lines 39a and 39b flows to the other auxiliary line. As such, even when for example the electrostatic current flows to the auxiliary line 39a or 39b, a break, fusion, or the like of the auxiliary lines 39a and 39b can be effectively prevented because the electrostatic current is distributed between the two auxiliary lines 39a and 39b.

As illustrated in FIGS. 3 and 4, a substrate line 42 is located on the TFT substrate 20 between the seal section 22 and a source line 29 positioned leftmost in a side-by-side direction, which is the left-right direction, of the source lines 29 along the leftmost source line 29.

FIG. 7 is a partial enlarged view of the substrate line 42. The substrate line 42 is long and plate-shaped. A plate surface of the substrate line 42 faces the back surface of the CF substrate 21. The width of a part of the substrate line 42 is narrower than the width of another part of the substrate line 42. Preferably, the width of the part of the substrate line 42 is extremely narrower than the width of the other part of the substrate line 42. According to the first embodiment, the substrate line 42 has a plurality of first parts 42a and a plurality of second pans 42b. In the substrate line 42, the first parts 42a and the second parts 42b are arranged alternately, and the ends of the first pans 42a are joined to the second parts 42b. The width of the first parts 42a is narrower than the width of the second parts 42b.

Accordingly, when an electric current flows through the substrate line 42 electric charge concentrates in the first parts 42a, and electric power is converted into heat energy. Therefore, even when the occurring static electricity flows to the auxiliary lines 39a and 39b, a portion of the static electricity is thereafter converted to heat energy while flowing through the substrate line 42 connected to the auxiliary line 39b, and the electrostatic current becomes small. As a result, the electrostatic current eau be prevented from flowing to the source lines 29.

As illustrated in FIG. 4, the substrate line 42 and the auxiliary line 39b arranged innermost on the TFT substrate 20 of the two auxiliary lines 39a and 39b are connected by a diode D3 (third diode) and a diode D4 (second diode). An anode of the diode D3 and a cathode of the diode D4 are connected to the auxiliary line 39b. A cathode of the diode D3 and an anode of the diode D4 are connected to the substrate line 42. The substrate line 42 is connected only to the diodes D3 and D4. The two diodes D3 and D4 constitute a diode ring.

As described previously, the substrate line 42 and the auxiliary line 39b are connected by the diodes D3 and D4. As such, when an electric current flowing through the auxiliary line 39b is large, a portion of the electric current flows to the substrate line 42. When an electric current flowing through the substrate line 42 is large, a portion of the electric current flows to the auxiliary line 39b. As such, the electrostatic current can be effectively prevented from flowing to the source lines 29 located along the substrate line 42.

Note that a substrate line is also located on the TFT substrate 20 between the seal section 22 and a source line 29 arranged rightmost in the left-right direction, along the rightmost source line 29. Additionally, the substrate line and the auxiliary line 39b are also connected by two diodes similarly to the left substrate line 42 and the auxiliary line 39b.

### Second Embodiment

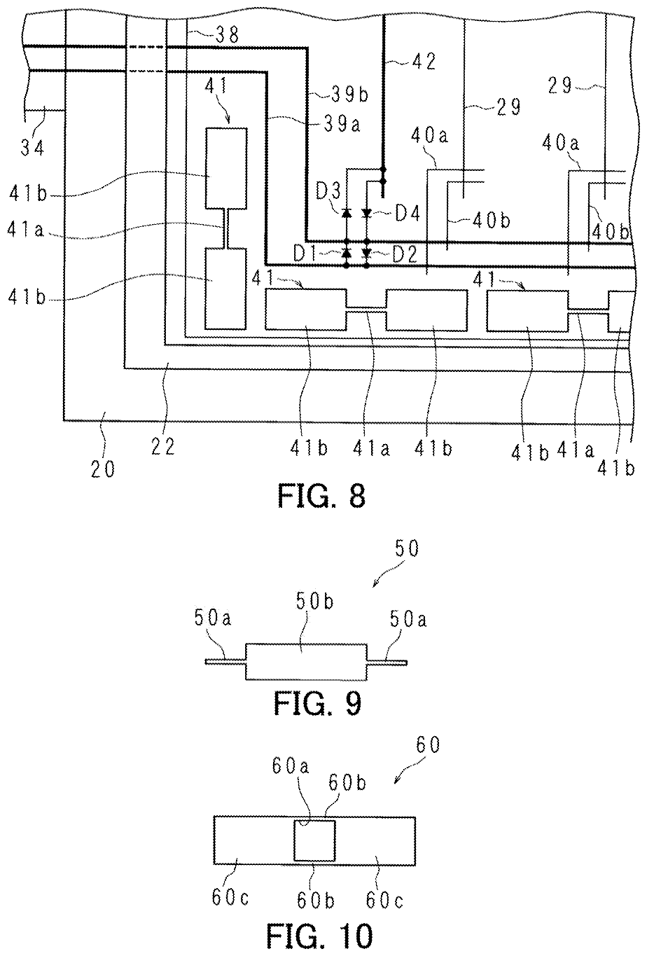

FIG. 8 is a partial front view of a liquid crystal panel 10 according to a second embodiment.

In the following, differences of the second embodiment from the first embodiments are described. Because configuration other than the configuration described in the following is the same as that in the first embodiment, the same elements of configuration as those in the first embodiment are labelled with the same reference signs and description thereof is omitted.

FIG. 8 corresponds to FIG. 4. In FIG. 8, a lower-left part of the liquid crystal panel 10 is illustrated with a CF substrate 21 and a polarizing plate 25 removed. In the liquid crystal panel 10 according to the second embodiment, a common line 38 is located inside of a seal section 22 similarly to the first embodiment. The common line 38 according to the second embodiment is arranged not only along a left part, an upper part, and a right part of the seal section 22 but also along a lower part of the seal section 22, thus forming a loop.

The common line 38 according to the second embodiment is connected to a common electrode 27 through the seal section 22 at a plurality of positions and conducts electricity to the common electrode 27 similarly to the first embodiment. Therefore, the potential of the entire common electrode 27 is stable.

According to the second embodiment as illustrated in FIG. 8, a plurality of conductors 41 are arranged between the common line 38 and a lowermost auxiliary line 39a of two auxiliary lines 39a and 39b which passes in a left-right direction. Accordingly, the conductors 41 are arranged between the auxiliary line 39a and the common line 38.

The liquid crystal panel 10 according to the second embodiment configured as above achieves the same effect as the liquid crystal panel 10 according to the first embodiment.

Note that according to the first and second embodiments, the numbers of printed substrates 31, printed substrates 34, source drivers 32, and gate drivers 35 are not limited to eight each, and may be any number of one or more. When there is one source driver 32, J is equal to M. When there is one gate driver 35, K is equal to M. Also, the numbers of printed substrates 31, printed substrates 34, source drivers 32, and gate drivers 35 need not be the same.

Furthermore, the number of narrow parts in a conductor 41 is not limited to one and may be two or more.

### Third Embodiment

FIG. 9 is an external view of a conductor 50 according to a third embodiment.

In the following, differences of the third embodiment from the first embodiment are described. Because configuration other than the configuration described in the following is with the same as that in the first embodiment, the same elements of configuration as those in the first embodiment are labelled with the same reference signs and description thereof is omitted.

A liquid crystal panel 10 according the third embodiment includes conductors 50 instead of conductors 41. In the liquid crystal panel 10 according to the third embodiment, the conductors 41 according to the first embodiment are replaced with the respective conductors 50. The conductors 50 according to the third embodiment are long and plate-shaped similarly to the conductors 41 according to the first embodiment. A plate surface of each of the conductors 50 faces a back surface of the CF substrate 21. The conductors 50 are arranged along a lower part of a seal section 22.

In each conductor 50 according to the third embodiment, the width of both ends 50a is narrower than a joint 50b which is a part other than the ends 50a. Preferably, the width of the ends 50a is extremely narrower than the width of the joint 50b.

As such, when an electric current flows through the conductor 50, electric charge concentrates in each end 50a and electric power is converted to heat energy. Therefore, because an electrostatic current flowing through the conductor 50 becomes small, the amount of static electricity moving from the conductor 50 to auxiliary lines 39a and 39b, which is the amount of electrostatic current flowing through the auxiliary lines 39a and 39b, can be reduced.

The liquid crystal panel 10 according to the third embodiment also achieves effects other than the effect obtained through the shape of the conductor 41 among the effects achieved by the liquid crystal panel 10 according to the first embodiment.

Note that in the liquid crystal panel 10 according to the second embodiment, the conductors 41 may be replaced with the conductors 50 according to the third embodiment. A liquid crystal panel 10 configured as such also achieves the same effect as the liquid crystal panel 10 according to the third embodiment.

Also according to the first and second embodiments, not all of the conductors 41 may each be replaced with a conductor 50 according to the third embodiment. Some of the conductors 41 may each be replaced with a conductor 50 according to the third embodiment.

### Fourth Embodiment

FIG. 10 is an external view of a conductor 60 according a fourth to embodiment.

In the following, differences of the fourth embodiment from the first embodiment will be described. Because configuration other than the configuration described in the following is the same as that in the first embodiment, the same elements of configuration as those in the first embodiment are labelled with the same reference signs and description thereof is omitted.

A liquid crystal panel 10 according to the fourth embodiment includes conductors 60 instead of conductors 41. In the liquid crystal panel 10 according to the fourth embodiment, the conductors 41 according to the first embodiment are replaced with the respective conductors 60. The conductors 60 according to the fourth embodiment are long and plate-shaped similarly to the conductors 41 according to the first embodiment. A plate surface of each of the conductor 60 faces a back surface of a CF substrate 21. The conductors 60 are arranged along a lower part of a seal section 22.

An opening 60a is provided in the center of a conductor 60. In the conductor 60, the width of central parts (two first parts 60b) is narrower than two second parts 60c other than the central parts. Preferably, the width of the central parts of the conductor 60 is extremely narrower than the parts other than the central parts.

As such, when an electric current flows through the conductor 60 electric charge concentrates in each of the first parts 60b and electric power is converted to heat energy. Therefore, because an electrostatic current flowing through the conductor 60 becomes small, the amount of static electricity moving from the conductor 60 to auxiliary lines 39a and 39b, which is the amount of electrostatic current flowing through the auxiliary lines 39a and 39b, can be reduced.

The liquid crystal panel 10 according to the fourth embodiment achieves effects other than the effect obtained through the shape of the conductor 41 among the effects achieved by the liquid crystal panel 10 according to the first embodiment.

Note that according to the fourth embodiment, the number of openings 60a is not limited to one and may be two or more.

Also in the liquid crystal panel 10 according to the second embodiment, the conductors 41 may be replaced with the conductors 60 according to the fourth embodiment. A liquid crystal panel 10 configured as above also achieves the same effect as the liquid crystal panel 10 according to the fourth embodiment.

Furthermore, according to the first and second embodiments, not all of the conductors 41 may each be replaced with a conductor 50 according to the third embodiment. Some of the conductors 41 may each be replaced with a conductor 60 according to the fourth embodiment.

Note that in the first through fourth embodiments, the shape of a conductor may be any shape having at least two features of those among a conductor 41 of the first embodiment, a conductor 50 of the third embodiment, and a conductor 60 of the fourth embodiment. Also, the conductors may not have the same shape as one another. Furthermore, the number of conductors may be one.

### Fifth Embodiment

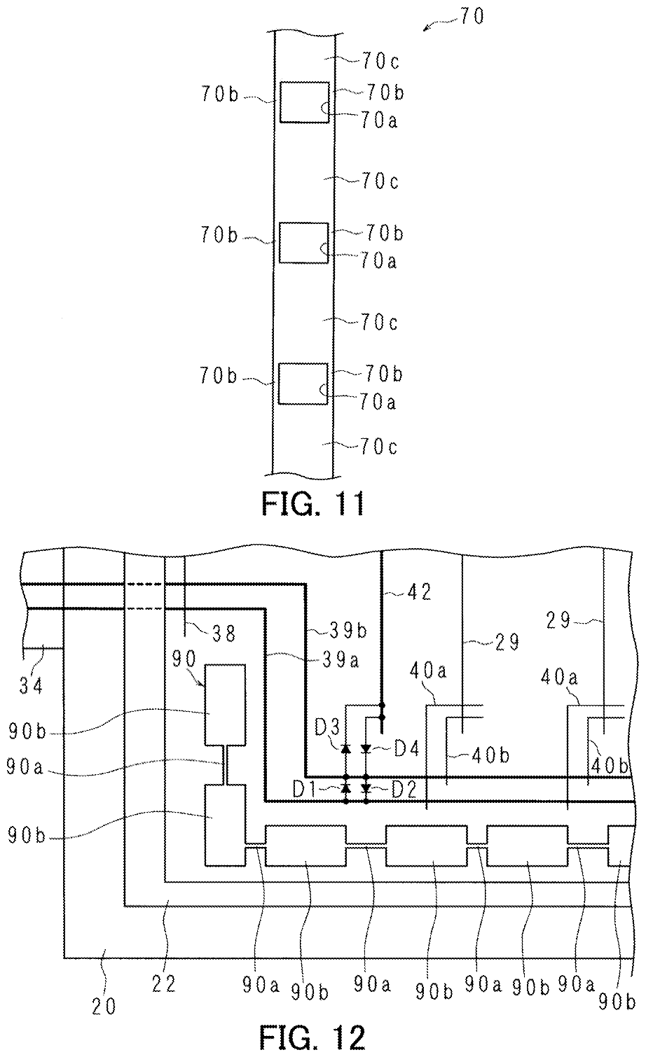

FIG. 11 is a partial enlarged view of a substrate line 70 according to a fifth embodiment.

In the following, differences of the fifth embodiment from the first embodiment will be described. Because configuration other than the configuration described in the following is the same as that in the first embodiment, the same elements of configuration as those in the first embodiment are labelled with the same reference signs and description thereof is omitted.

A liquid crystal panel 10 according to the fifth embodiment includes a substrate line 70 instead of the substrate line 42. In the liquid crystal panel 10 according to the fifth embodiment, the substrate line 42 according to the first embodiment is replaced with the substrate tine 70. The substrate line 70 according to the fifth embodiment is long and plate-shaped similarly to the substrate line 42 according to the first embodiment. A plate surface of the substrate line 70 faces a back surface of a CF substrate 21.

In the substrate line 70, a plurality of openings 70a are serially provided in a longitudinal direction of the substrate line 70. The substrate line 70 has a plurality of first parts 70b and a plurality of second parts 70c. The second parts 70c are also serially provided in the longitudinal direction of the substrate line 70. Two adjacent second parts 70c are connected by two first parts 70b.

The width of the first parts 70b is narrower than the width of the second parts 70c which are parts other than the first parts 70b.

Accordingly, when an electric current flows through the substrate line 70, electric charge concentrates in the first parts 70b, and electric power is converted into heat energy. Therefore, an electrostatic current flowing through the substrate line 70 becomes small. As a result, the electrostatic current can be prevented from flowing.

The liquid crystal panel 10 according to the fifth embodiment configured as above achieves the same effects as those of the first embodiment.

### Sixth Embodiment

FIG. 12 is a partial front view of a liquid crystal panel 10 according to a sixth embodiment.

In the following, points of difference of the sixth embodiment from the first embodiment will be described. Because configuration other than the configuration described in the following is the same as that of the first embodiment, the same elements of configuration as those in the first embodiment are labelled with the same reference signs and description thereof is omitted.

In a TFT substrate 20 of the liquid crystal panel 10 according to the sixth embodiment, a single conductor 90 is arranged instead of the conductors 41. The conductor 90 is arranged between an auxiliary line 39a and a seal section 22 and arranged between an auxiliary line 39b and the seal section 22. The conductor 90 is not electrically connected to another conductor, and is for example entirely covered with an insulator.

The conductor 90 is plate-shaped, and a plate surface of the conductor 90 faces a back surface of a CF substrate 21. The conductor 90 is arranged over an entire area surrounded by the seal section 22 and the auxiliary line 39a. The width of a part of the conductor 90 is narrower than another part of the conductor 90. Preferably, the width of the part of the conductor 90 is extremely narrow with respect to the other part of the conductor 90. According to the sixth embodiment, the conductor 90 has a plurality of first parts 90a and a plurality of second parts 90b. In the conductor 90, the first parts 90a and the second parts 90b are arranged alternately, and the first parts 90a are joined to the second parts 90b. The width of the first parts 90a is narrower than the width of the second parts 90b.

As described in the first embodiment, static electricity occurs on the CF substrate 21 when work of detaching the polarizing plate 25 from the CF substrate 21 is performed. The occurring static electricity flows along the seal section 22 to the TFT substrate 20 and moves to the conductor 90 arranged in the vicinity of the seal section 22 to flow on to the conductor 90. Thus, the amount of the static electricity flowing to auxiliary lines 39a and 39b through the lower part of the seal section 22 can be reduced. Accordingly, a break or fusion of the auxiliary lines 39a and 39b or the wiring the active area (source line 29 or gate line 30) by the static electricity can be prevented. Furthermore, destruction of a circuit element of a TFT 28 or the like by the static electricity can be prevented.

Also in the conductor 90, the width of the first parts 90a is narrower than the width of the second parts 90b. Accordingly, when the electrostatic current flows through the conductor 90, electric charge concentrates in the first parts 90a and electric power is converted into heat energy. Therefore, because the electrostatic current flowing through the conductor 90 becomes small, the amount of static electricity moving from the conductor 90 to the auxiliary lines 39a and 39b, which is the amount of electrostatic current flowing through the auxiliary lines 39a and 39b, can be reduced.

The liquid crystal panel 10 according to the sixth embodiment also achieves effects other than the effect obtained by arranging the conductors 41 among the effects achieved by the liquid crystal panel 10 according to the first embodiment.

Note that in the liquid crystal panel 10 according to the second embodiment, the conductors 41 may be replaced by the single conductor 90.

Also, in the first through fourth and sixth embodiments, the number of first parts 42a of the substrate line 42 may be one. In the substrate line 70 according to the fifth embodiment, the number of openings 70a may be one.

Furthermore, according to the first through fourth and sixth embodiments, the substrate line 42 may be replaced with the substrate line 70 according to the fifth embodiment.

Also in the first through sixth embodiments, the shape of the substrate fine 42 may be any shape having features of the substrate line 42 of the first embodiment and the substrate line 70 of the fifth embodiment. Furthermore, the shape of the ends of the substrate line may be the same shape as the ends 50a of each conductor 50 according to the third embodiment.

Furthermore, in the first through sixth embodiments, the number of auxiliary lines is not limited to two and may be one, three, or more. In a configuration where the number of auxiliary lines is three or more, the auxiliary lines are also arranged side by side, and the aforementioned diode ring is formed between adjacent auxiliary lines. Accordingly, the number of diode rings is ((number of auxiliary lines)−1) or more. Also, a diode ring is formed between the substrate line 42 and an auxiliary line located innermost on the TFT substrate 20. The number of connecting lines provided for each of the source lines 29 is the same as the number of auxiliary lines.

Note that the presently disclosed embodiments are merely examples in all respects and should not be construed to be limiting. The scope of the present invention is indicated by the claims, rather than by the description given above, and includes all variations that are equivalent in meaning and scope to the claims.

### REFERENCE SIGNS LIST

1 Display device
10 Liquid crystal panel
11 Backlight device (irradiating section)
20 TFT substrate
21 CF substrate
22 Seal section (joining member)
23 Liquid crystal
26 Pixel electrode
27 Common electrode (second electrode)
29 Source line (electrode line)
38 Common line (second electrode line)
39a, 39b Auxiliary line (internal line)

### 41, 50, 60, 90 Conductor

41a Center (part of conductor)

### 41b, 50b Joint

42, 70 Substrate line
42a, 70b First part (part of substrate line)
42b, 70c Second part
50a End (part of conductor)
60b, 90a First part (part of conductor)
60c, 90b Second part

### D1, D2 Diode

D3 Diode (third diode)
D4 Diode (second diode)

1. A liquid crystal panel in comprising:
two substrates;
a joining member arranged between the two substrates along peripheral edges of the substrates with a space therebetween and joining the two substrates;
a liquid crystal enclosed inside of the joining member;
at least one internal line located on one of the two substrates inside of the joining member along the joining member; and
a conductor arranged on the one substrate between the joining member and the at least one internal line so as to be out of contact with the joining member and the at least one internal line.

2. The liquid crystal panel according to claim 1, wherein
the conductor is out of contact with another conductor.

3. The liquid crystal panel according to claim 1, wherein
the conductor is plate-shaped, and
a width of a part of the conductor is narrower than a width of another part of the conductor.

4. The liquid crystal panel according to claim 3, wherein
the part of the conductor is provided in a center of the conductor.

5. The liquid crystal panel according to claim 1, wherein
the at least one internal line comprises two or more internal lines,
the two or more internal lines are arranged side by side,
the liquid crystal panel further comprises two diodes which connect two adjacent internal lines of the two or more internal lines,
a cathode of one of the two diodes and an anode of the other of the two diodes are connected to one of the two adjacent internal lines,
an anode of the one diode and a cathode of the other diode are connected to another of the two adjacent internal lines.

6. The liquid crystal panel according to claim 5, further comprising:
a plurality of electrodes located on the one substrate and configured to apply voltage to the liquid crystal;
a plurality of electrode lines arranged side by side on the one substrate and connected to at least one of the plurality of electrodes;
a substrate line located on the one substrate along an electrode line of the plurality of electrode lines positioned outermost in a side-by-side direction;
a second diode having a cathode and an anode, the cathode being connected to an internal line of the two or more internal lines arranged innermost on the one substrate, the anode being connected to the substrate line; and
a third diode having a cathode and an anode, the anode being connected to the internal line arranged innermost on the one substrate, the cathode being connected to the substrate line, wherein
the substrate line is connected only to the second diode and the third diode.

7. The liquid crystal panel according to claim 6, wherein
a width of a part of the substrate line is narrower than a width of another part of the substrate line.

8. The liquid crystal panel according to claim 1, further comprising:
a second electrode located on another of the two substrates and configured to apply voltage to the liquid crystal; and
a second electrode line located on the one substrate inside of the joining member along the joining member and configured to conduct electricity to the second electrode, wherein
the conductor is arranged between the at least one internal line and the second electrode line.

9. A display device comprising:
the liquid crystal panel according to claim 1; and
an irradiating section configured to irradiate the liquid crystal panel with light, wherein
the liquid crystal panel displays an image using the light radiated by the irradiating section.
